(19) United States
(12) Patent Application Publication
(10) Pub. No.: US 2012/0036706 A1
(43) Pub. Date: Feb. 16, 2012

(54) Row bar for forming sliders and method of manufacturing slider

(75) Inventors: Waikeung Lau, DongGuan (CN); Guowei Li, DongGuan (CN); Yasutoshi Fujita, Dongguan (CN); Quanbao Wang, DongGuan (CN); Xiangbin Xiao, DongGuan (CN); Longping Wang, DongGuan (CN)

(73) Assignee: SAE Magnetics (H.K.) Ltd., Hong Kong (CN)

(21) Appl. No.: 12/926,416

(22) Filed: Nov. 16, 2010

(30) Foreign Application Priority Data
Aug. 13, 2010 (CN) 201010261127.0

(51) Int. Cl. G11B 5/127; B23P 19/00

(52) U.S. Cl. 29/603.01; 29/739

(57) ABSTRACT

A row bar for forming sliders has a row of slider forming portions, each slider forming portion having a slider to be cut from the row bar and a medial region adjacent the slider, each medial region having a first guide pad disposed thereon; wherein each slider has: a slider body; a magnetic writer and a magnetic reader disposed on the slider body; a second guide pad disposed on the slider body; two electrical lapping guides disposed on the slider body and electrically connecting to the first guide pad and the second guide pad respectively; a row of bonding pads formed on the slider body and electrically connecting to the magnetic reader and the magnetic writer; and a grounding pad disposed on the slider body and electrically connecting to the first guide pad and the second guide pad. The invention also discloses a method of manufacturing the slider.

This application claims priority to Chinese Application No. 201010261127.0, filed 13 Aug. 2010, the entire content of which is hereby incorporated by reference.

### FIELD OF THE INVENTION

The present invention relates to information recording disk drive devices, and more particularly, to a row bar for forming sliders and a method of manufacturing the slider.

### BACKGROUND OF THE INVENTION

Perpendicular magnetic recording is a promising recording technique in which magnetic data bits on a magnetic recording disk are defined, such that their magnetic moments are perpendicular to the plane of the magnetic recording disk. The progress to perpendicular recording from longitudinal recording is seen as one of the advances that will allow the continued increase in data densities on magnetic recording disks in the future.

A slider of the perpendicular recording method has a thin film coil for generating a magnetic flux and a magnetic pole layer extending rearward from an air bearing surface and emitting the magnetic flux generated by the thin film coil toward a recording medium. The magnetic pole layer includes, for example, a track width specifying part having a width (uniform width) specifying the recording track width of a recording medium. The height of the track width specifying part in the magnetic pole layer, that is, the distance from the front end (the edge exposed in the air bearing surface) of the track width specifying part to the rear end (the edge on the side far from the air bearing surface) is a neck height as an important factor contributing to recording performances of the slider. In the slider of the perpendicular recording method, when current is passed to a thin film coil and a magnetic flux for recording is generated, the magnetic flux is emitted from the tip of the track width specifying part of the magnetic pole layer, thereby generating a magnetic field for recording (perpendicular magnetic field), and the surface of the recording medium is magnetized on the basis of the perpendicular magnetic field. In such a manner, information is magnetically recorded on the recording medium. Recently, a composite-type slider having not only the function of performing a recording process on a recording medium, but also the function of performing a reproducing process on the recording medium.

In a process of manufacturing the slider, the magnetic head structure is cut in rows of the magnetic head precursors, thereby obtaining a plurality of magnetic head row bars. After that, one end face (a cut face of the magnetic head structure) of the magnetic head row bar is polished so that the dimension of each of the polished reproducing head portion and the polished recording head portion becomes a predetermined dimension, concretely, the MR height of the reproducing head portion becomes a predetermined dimension and the neck height of the recording head portion becomes a predetermined dimension thereby forming an air bearing surface. After that, the magnetic head row bar in which the air bearing surfaces are formed is cut magnetic heads, thereby obtaining a plurality of sliders.

To assure operation performance of the composite thin film magnetic head, it is necessary to determine both of the neck height contributing to the recording performance and the MR height contributing to the reproducing performance with high precision, which are defined in the lapping process. Controlling the lapping process is typically achieved through the use of electrical lapping guides (ELGs) which are placed in multiple locations on the magnetic head row bar. Traditionally, an ELG is a metal layer deposits between two sliders, while the ELG is placed on the slider in the improved technology recently. In some instances, the slider may also include one or more ELGs. The ELG has a resistance that varies as the material is removed during a lapping process and thus may be used to monitor lapping during slider manufacturing. Lapping the ELG causes the electrical resistance to increase. By monitoring the ELG along the row bar and adjusting the pressure being applied to the row bar at different locations along its length, lapping process can be controlled. Lapping process is terminated when the ELG resistance reaches the threshold value.

In order to access the elements mounted on the slider (the magnetic reader, the magnetic writer, and the one or more ELGs), a plurality of contact pads may be provided on the sliders and connected to the elements. Some of the contact pads and slider elements may be used to perform disk access operations (e.g., the bonding and testing pads). Nevertheless, some of the contact pads and the slider elements may only be used during manufacture of the hard disk drive (e.g., the contact pads for the one or more ELGs). The space of the slider is too limited to locate several contact pads thereon. Due to a plurality of the contact pads and the complicated electrical connections formed on the slider, it is easy to create a short circuit between a contact pad and the adjacent pad, thus damaging the slier operation.

Accordingly, a need has arisen for providing an improved row bar for forming sliders and the method of manufacturing the slider, which provide a new contact pads layout to achieve improvement of the slider performance, to overcome the above-mentioned drawbacks.

### SUMMARY OF THE INVENTION

One objective of the present invention is to provide a row bar for forming sliders, the row bar having a row of slider forming portions, each slider forming portion having a medial region adjacent the slider with first guide pad which is connecting to the ELG disposed thereon, thereby the region between two sliders associated with the row bar can be taken full advantage of, and the flexible lapping connection could be achieved.

Another objective of the present invention is to provide a method of manufacturing a slider cut from a row bar, the row bar having a row of slider forming portions, each slider forming portion having a medial region adjacent the slider with first guide pad which is connecting to the ELG disposed thereon, thereby the region between two sliders associated with the row bar can be taken full advantage of, and the flexible lapping connection could be achieved.

To achieve the above-mentioned objects, the present invention provides a row bar for forming sliders, and the row bar comprises a row of slider forming portions, each slider forming portion comprising a slider to be cut from the row bar and a medial region adjacent the slider, each medial region having a first guide pad disposed thereon; wherein each slider comprises: a slider body; a magnetic writer disposed on the slider body; a magnetic reader disposed on the slider body; a second guide pad disposed on the slider body; two electrical lapping guides disposed on the slider body and electrically connecting to the first guide pad and the second guide pad respectively; a row of bonding pads formed on the slider body and electrically connecting to the magnetic reader and the magnetic writer; and a grounding pad disposed on the slider body and electrically connecting to the first guide pad and the second guide pad.

As an embodiment of the present invention, the second guide pad is arranged in a different row from that of the bonding pads.

As another embodiment of the present invention, the grounding pad and the second guide pad are arranged in a row which is different from that of the bonding pads.

As still another embodiment of the present invention, the grounding pad is arranged in the row of the bonding pads.

As another embodiment of the present invention, the first guide pad is in both rows of the bonding pad and the second guide pad.

As yet another embodiment of the present invention, the grounding pad is arranged between the first guide pad and the second guide pad.

As still another embodiment of the present invention, the electrical connection distance between the first guide pad and the grounding pad is identical with that between the grounding pad and the second guide pad.

As yet another embodiment of the present invention, the two electrical lapping guides are aligned in a row vertical with a horizontal line.

The present invention also provides a method of manufacturing a slider, the method comprises: providing a row bar having a row of slider forming portions, each slider forming portion comprising a slider body and a medial region adjacent the slider body; forming a magnetic reader on each slider body; forming a first electrical lapping guide on each slider body; forming a magnetic writer on each slider body; forming a second electrical lapping guide on each slider body; forming a first guide pad on each medial region, forming a second guide pad, a grounding pad and a row of bonding pads on each slider body, electrically connecting the two electrical lapping guides which includes the first electrical lapping guide and the second electrical lapping guide to the first guide pad and the second guide pad respectively, electrically connecting the bonding pads to the magnetic reader and the magnetic writer, and electrically connecting the grounding pad to the first guide pad and the second guide pad; lapping the row bar with the guide of the two electrical lapping guides; cutting the slider bodies to obtain sliders from the row bar.

In comparison with the prior art, the row bar for forming sliders has a row of slider forming portions, each slider forming portion having a medial region adjacent the slider with first guide pad which is connecting to the ELG disposed thereon, thereby the region between two sliders associated with the row bar can be taken full advantage of, and the flexible lapping connection could be achieved.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a schematic illustration of a row bar according to the first embodiment of the invention;

FIG. 2 is a partial schematic illustration of the row bar shown in FIG. 1;

FIG. 3 is a schematic illustration of a slider forming portion of the row bar according to the first embodiment of the invention;

FIG. 4 is a schematic illustration of the slider in the direction A according to FIG. 3;

FIG. 5 is a schematic illustration of a slider forming portion of a row bar according to the second embodiment of the invention;

FIG. 6 is schematic illustration of a slider, forming portion according to the third embodiment of the invention;

FIG. 7 is a flow chart illustrating a method of manufacturing a slider from a row bar according to the embodiment of the invention.

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a row bar for forming sliders, and the row bar has a row of slider forming portions, each slider forming portion having a medial region adjacent the slider with first guide pad which is connecting to the ELG disposed thereon, thereby the region between two sliders associated with the row bar can be taken full advantage of, and the flexible lapping connection could be achieved.

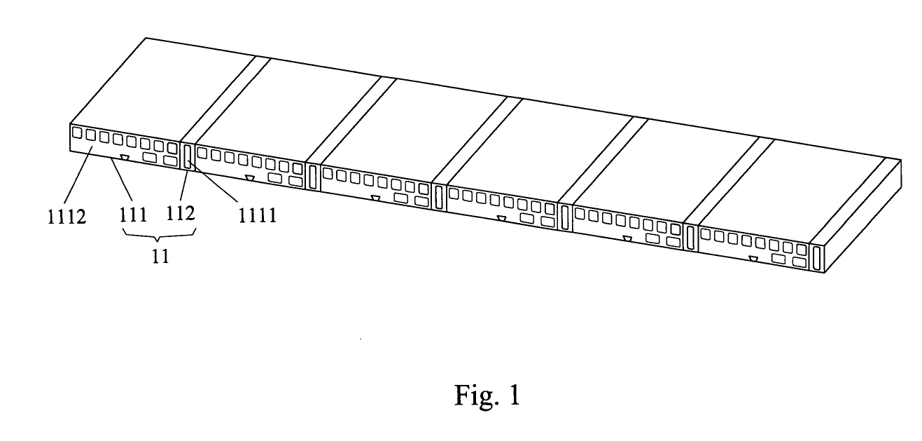

FIG. 1 demonstrates a row bar according to the first embodiment of the invention. As known in the art, a row bar which is cut from a wafer is using for forming sliders. The row bar 1 has a plurality of slider forming portions 11 which are arranged in a row. Each slider forming portion 11 has a slider 111 to be cut from the row bar 1 and a medial region 112 adjacent the slider 111. Each medial region 112 has a first guide pad 1111 disposed thereon. In accordance with the first embodiment, the first guide pad 1111 is placed between the slider 111 and the adjacent slider 111. Furthermore, between every two adjacent sliders 111 there is a first guide pad 1111 corresponding to one slider 111. The first guide pad 1111 is electrically connected to the Electrical Lapping Guide (ELG) which is disposed on the slider 111, and the first guide pad 1111 is only employed during slider manufacturing, such as the lapping process.

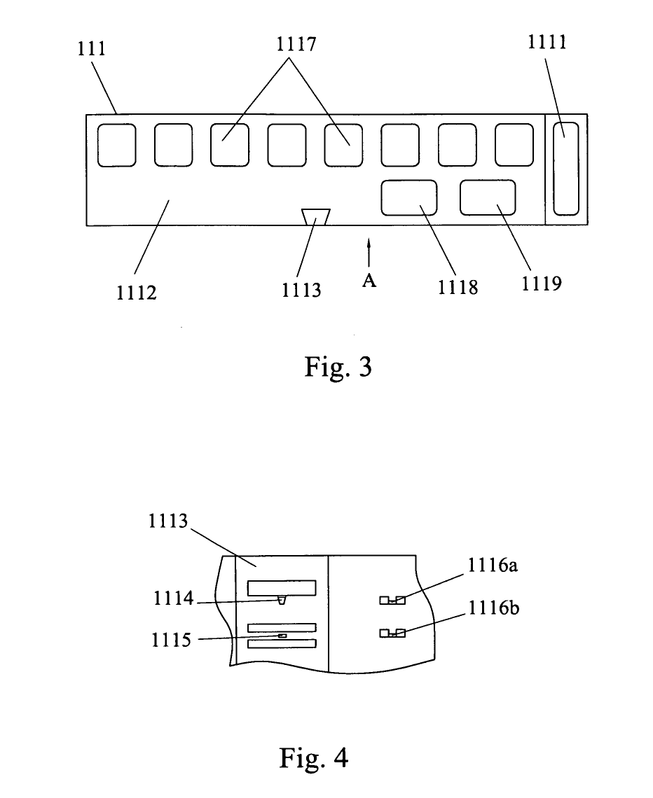

Referring to FIGS. 1-4, the slider 111 has a slider body with a trailing surface 1112. There is a pole tip 1113 mounted on the trailing surface 1112, and the pole tip 1113 is positioned in the center of the trailing surface 1112. A magnetic writer 1114 and a magnetic reader 1115, which carry out reproducing and recording information of the slider 111, are disposed in the pole tip 1113, and the magnetic writer 1114 and the magnetic reader 1115 are arranged to align in the approximately center line position of the trailing surface 1112. There are several magnetic layers or non-magnetic layers deposited to form the pole tip 1113, and the magnetic writer 1114 and the magnetic reader 1115 are deposited on different layer in the pole tip 1113. The slider 111 has a first electrical lapping guide 1116a and the second electrical lapping guide 1116b disposed on the slider body. Concretely, referring to FIGS. 3-4, the surface which is vertical with the trailing surface 1112 according to the direction A is the Air Bearing Surface (ABS). The first electrical lapping guide 1116a and the second electrical lapping guide 1116b are disposed on the ABS, with the first electrical lapping guide 1116a and the second electrical lapping guide 1116b aligned in a row vertical with a horizontal line. In wafer fabrication process, the magnetic writer 1114 and the first electrical lapping guide 1116a are aligned at the same line, which are build in the same process; and the magnetic reader 1115 and the second electrical lapping guide 1116b are aligned at the some line, which are build in the same process as well. Accordingly, the first electrical lapping guide 1116a and the second electrical lapping guide 1116b could act as the guide to controlling the lapping process performed more accurately, whereby the magnetic writer 1114 and the magnetic reader 1115 with high accuracy would be obtained,

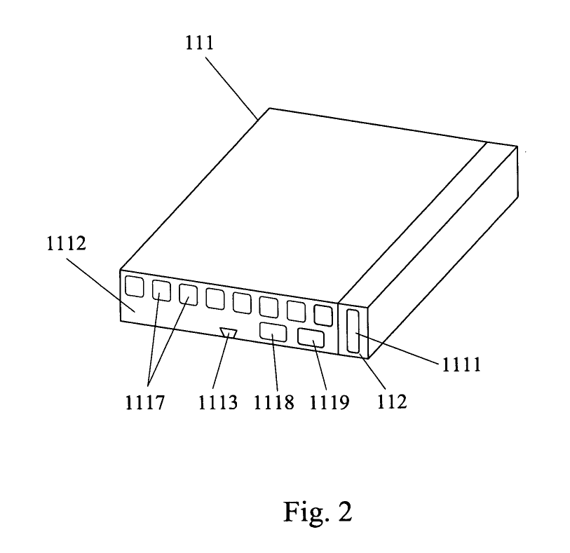

Referring to FIGS. 2-4, a row of bonding pads 1117 are formed on the trailing surface 1112, which are electrically connecting to the magnetic writer 1114 and the magnetic reader 1115. The first guide pad 1111 disposed adjacent the slider 111 is electrically connecting to the second electrical lapping guide 1116b. A second guide pad 1118 is disposed on the trailing surface 1112 and electrically connecting to the first electrical lapping guide 1116a. A grounding pad 1119 is disposed on the trailing surface 1112 as well and it is electrically connecting to the first guide pad 1111 and the second guide pad 1118. In this embodiment, the grounding pad 1119 and the second guide pad 1118 are arranged in a row which is different from the row of the bonding pads 1117. The first guide pad 1111 is a strip shape which is in both rows of the bonding pad 1117 and the second guide pad 1118. In addition, the grounding pad 1119 is arranged between the first guide pad 1111 and the second guide pad 1118. The electrical connection distance between the first guide pad 1111 and the grounding pad 1119 is identical with that between the grounding pad 1119 and the second guide pad 1118, thereby facilitating manufacturing the slider 111. The electrical connection points of the second guide pad 1118, the first guide pad 1111 and the grounding pad 1119 are aligned in a line, which achieves good connection and flexibility in lapping process.

Referring to FIGS. 1-4, during the lapping process, a testing voltage is applied on the first guide pad 1111 and the second guide pad 1118 which are respectively electrically connected to the second electrical lapping guide 1116b and the first electrical lapping guide 1116a. Lapping the magnetic writer 1114 and the first electrical lapping guide 1116a synchronously, and lapping the magnetic reader 1115 and the second electrical lapping guide 1116b synchronously. The lapping process is under control via testing the resistance of the first electrical lapping guide 1116a and the second electrical lapping guide 1116b. Lapping process is terminated when the resistance value reaches the threshold. Due to the first guide pad 1111 is disposed in the medial region 112, the region between two sliders 111 associated with the row bar 1 can be taken full advantage of, and the flexible lapping connection could be achieved, thus minimize the difficult of the electrical connection in the lapping process.

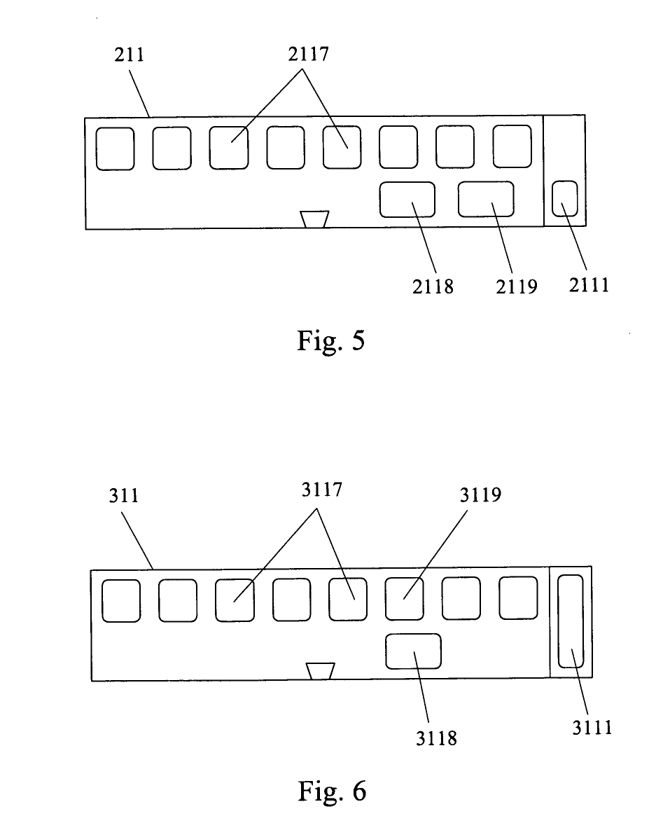

FIG. 5 is a schematic illustration of a slider forming portion of a row bar according to the second embodiment of the invention. The structure of the slider 211 of the second embodiment is similar to that of the slider 111 of the first embodiment shown in FIG. 3, except the shape of the first guide pad 2111. Referring to FIG. 5, in the second embodiment, the slider 211 also has a trailing surface 2112 with a row of bonding pad 2117 formed thereon, a second guide pad 2118 and a grounding pad 2119 formed thereon. The first guide pad 2111 is only located in the row of the second guide pad 2118 and the grounding pad 2119.

FIG. 6 is a schematic illustration of a slider forming portion according to the third embodiment of the invention. The structure of the slider 311 of the third embodiment is similar to that of the slider 1 of the first embodiment shown in FIG. 3, except the position of the grounding pad 3119. Referring to FIG. 6, the grounding pad 3119 is arranged in the row of the bonding pads 3117, and its position should be random in the row of the bonding pads 3117 which depends on the electrical connection thereof. Optionally, one of the bonding pads 3117 could be placed aligned the second guide pad 3118 to form a row, which is different from that of the bonding pads 3117. Due to the first guide pad 3111 is a strip shape which is in both rows of the bonding pad 3117 and the second guide pad 3118, the electrical connections among the first guide pad 3111, the second guide pad 3118 and the grounding pad 3119 are more flexible for lapping process.

According to the above embodiments of the invention, it should be noted that the corresponding connection of the two guide pads and two lapping guides can be swapped.

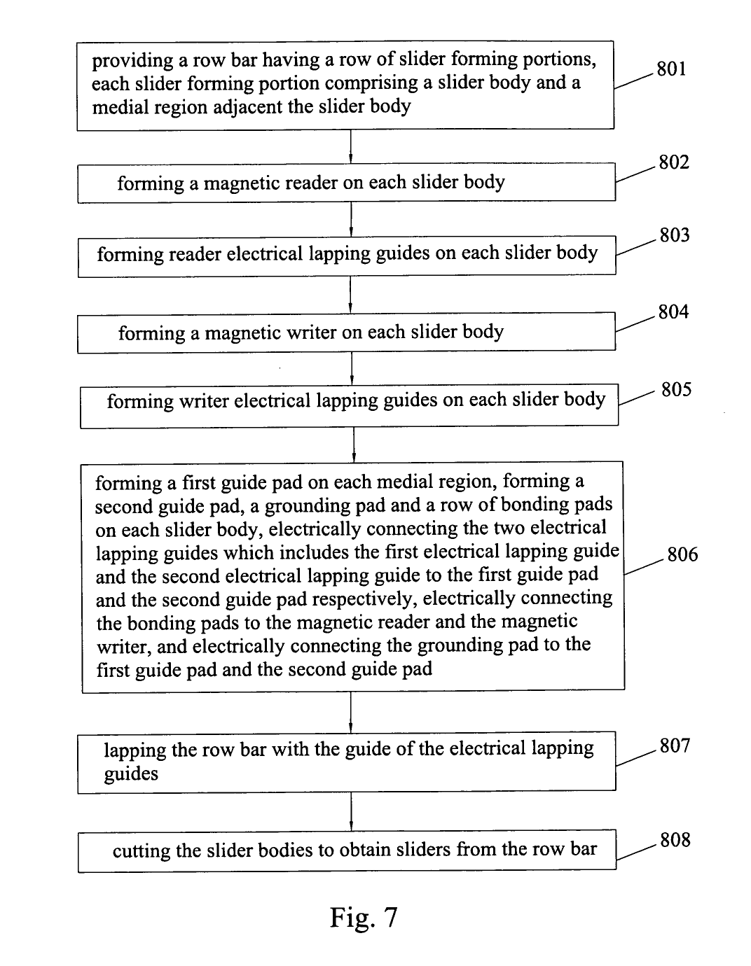

FIG. 7 is a flow chart illustrating the method of manufacturing a slider from a row bar according to a preferential embodiment of the invention, and the method is carried out in the following order: providing a row bar having a row of slider forming portions, each slider forming portion comprising a slider body and a medial region adjacent the slider body (step 801); forming a magnetic reader on each slider body (step 802); forming a first electrical lapping guide on each slider body (step 803); forming a magnetic writer on each slider body (step 804); forming a second electrical lapping guide on each slider body (step 805); forming a first guide pad on each medial region, forming a second guide pad, a grounding pad and a row of bonding pads on each slider body, electrically connecting the two electrical lapping guides which includes the first electrical lapping guide and the second electrical lapping guide to the first guide pad and the second guide pad respectively, electrically connecting the bonding pads to the magnetic reader and the magnetic writer, and electrically connecting the grounding pad to the first guide pad and the second guide pad (step 806); lapping the row bar with the guide of the two electrical lapping guides (step 807); cutting the slider bodies to obtain sliders from the row bar (step 808).

Perfectly, after the step 808, the method of manufacturing the slider according to the present invention further comprises that wiping out the two electrical lapping guides which are located on the ABS.

The above-mentioned steps according to the method of the invention could either in proper order, or in any other order, which are depends on the specific manufacturing method. The method in accordance with manufacturing the slider from a row bar is applied for the above-mentioned embodiments.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A row bar for forming sliders, comprising a row of slider forming portions, each slider forming portion comprising a slider to be cut from the row bar and a medial region adjacent the slider;
wherein each medial region has a first guide pad disposed thereon;
wherein each slider comprises:
a slider body;
a magnetic writer disposed on the slider body;
a magnetic reader disposed on the slider body;
a second guide pad disposed on the slider body;
two electrical lapping guides disposed on the slider body and electrically connecting to the first guide pad and the second guide pad respectively;
a row of bonding pads formed on the slider body and electrically connecting to the magnetic reader and the magnetic writer; and
a grounding pad disposed on the slider body and electrically connecting to the first guide pad and the second guide pad.

2. The row bar according to claim 1, wherein the second guide pad is arranged in a different row from that of the bonding pads.

3. The row bar according to claim 2, wherein the grounding pad and the second guide pad are arranged in a row which is different from that of the bonding pads.

4. The row bar according to claim 2, wherein the grounding pad is arranged in the row of the bonding pads.

5. The row bar according to claim 2, wherein the first guide pad is in both rows of the bonding pad and the second guide pad.

6. The row bar according to claim 1, wherein the grounding pad is arranged between the first guide pad and the second guide pad.

7. The row bar according to claim 6, wherein the electrical connection distance between the first guide pad and the grounding pad is identical with that between the grounding pad and the second guide pad.

8. The row bar according to claim 1, wherein the two electrical lapping guides are aligned in a row vertical with a horizontal line.

9. A method of manufacturing a slider, the method comprising:
providing a row bar having a row of slider forming portions, each slider forming portion comprising a slider body and a medial region adjacent the slider body;
forming a magnetic reader on each slider body;
forming a first electrical lapping guide on each slider body;
forming a magnetic writer on each slider body;
forming a second electrical lapping guide on each slider body;
forming a first guide pad on each medial region, forming a second guide pad, a grounding pad and a row of bonding pads on each slider body, electrically connecting the two electrical lapping guides which includes the first electrical lapping guide and the second electrical lapping guide to the first guide pad and the second guide pad respectively, electrically connecting the bonding pads to the magnetic reader and the magnetic writer, and electrically connecting the grounding pad to the first guide pad and the second guide pad;
lapping the row bar with the guide of the two electrical lapping guides;
cutting the slider bodies to obtain sliders from the row bar.

10. The method according to claim 9, wherein the second guide pad is arranged in a different row from that of the bonding pads.

11. The method according to claim 10, wherein the grounding pad and the second guide pad are arranged in a row which is different from that of the bonding pads.

12. The method according to claim 10, wherein the grounding pad is arranged in the row of the bonding pads.

13. The method according to claim 10, wherein the first guide pad is in both rows of the bonding pad and the second guide pad.

14. The method according to claim 9, wherein the grounding pad is arranged between the first guide pad and the second guide pad.

15. The method according to claim 14, wherein the electrical connection distance between the first guide pad and the grounding pad is identical with that between the grounding pad and the second guide pad.

16. The method according to claim 10, wherein the two electrical lapping guides are aligned in a row vertical with a horizontal line.
